(19) United States
(12) Patent Application Publication
(10) Pub. No.: US 2004/0148258 A1
(43) Pub. Date: Jul. 29, 2004

(54) Electronic check settlement method

(76) Inventor: Wiley S. Tillett, Ridgeway, SC (US)

Correspondence Address: WILLIAM J. MASON, MACCORD MASON PLLC, POST OFFICE BOX 1489, WRIGHTSVILLE BEACH, NC, 28480, US

(21) Appl. No.: 10/353,560

(22) Filed: Jan. 29, 2003

(51) Int. Cl. G06F 17/60

(52) U.S. Cl. 705/42

(57) ABSTRACT

A method of settling a plurality of purchases by purchasers from a merchant wherein payment is made by checks including some purchases requiring off-line settlement and other purchases requiring online settlement. Transaction information relating to each purchase is acquired that includes the MICR information of the check presented by the purchaser, the amount of the purchase, and the merchant identification. The transaction information is interrogated by a settlement entity to identify transactions requiring off-line settlement and transactions previously settled by an online processing entity. The settlement entity transmits transactions requiring off-line settlement to an off-line settlement entity for settlement, debits an internal due from processor account and credits the merchant for the value of the transactions previously settled online and offline.

### BACKGROUND OF THE INVENTION

(1) Field of the Invention

This invention relates to a system for facilitating the settlement of electronic checking transactions, and in particular to a system for settling electronic checking transactions when some of the transactions are processed through the ACH network and some of the transactions are processed by online processors, such as Visa POS Check Service or SafeCHECK.

(2) Description of the Prior Art

Historically, purchasers who wished to acquire goods or services from a merchant with their bank account funds presented a paper check to the merchant. The merchant then physically sent the check through the banking system for collection and deposit of the funds into the merchant's account. Check approval and fraud protection basically consisted of confirming the purchaser's identity by looking at his or her driver's license.

Debit cards were developed to eliminate paperwork, expedite deposit of funds into the merchant's account, and reduce fraud. When paying for a purchase with a debit card, the purchaser or merchant swipes the debit card through a reader to acquire the banking information present on the magnetic strip on the back of the card. This information and the amount of the purchase is then electronically sent to the issuing bank for approval. The amount of the purchase is then debited from the purchaser's account and a deposit is made to the merchant's account.

While the use of debit cards has increased, the majority of non-cash point-of-sale purchases from retail establishments are still made with paper checks. A 1999 study (note: revised fed study) estimated that over 68 billion checks were processed annually, with over one-half of these checks being consumer checks. An annual growth of as much as 2% is also projected through 2005. Therefore, variations of debit card and ATM card processing has also evolved to permit “electronic checking” wherein a paper check is used instead of a debit card. In electronic checking, the purchaser presents a paper check, either blank or completed, to the merchant. The merchant then swipes the check through a magnetic ink character recognition (MICR) reader to acquire the bank account information, i.e., the bank routing number and consumer account number, printed on the bottom of the check. The MICR information, known as raw MICR, and the amount of the purchase are then sent electronically to a check verification entity, or verifier, such as Rocky Mountain Retail Systems (RMRS) for checking of the transaction information against a database of checking information, normally the National Check Network (NCN), which is an organization of more than 60 collection agencies who contribute negative and positive check writing data to the database.

The verifier then advises the merchant if the check is approved or disapproved. If approved, the merchant processes the transaction. Transaction information comprised of purchaser bank account information, the purchase amount, and merchant bank account information is then sent through the automated clearinghouse system (ACH) for off-line settlement.

More recently, online settlement processors, notably Visa POS Check Service and SafeCHECK, have begun to offer processing services that bypass the traditional ACH settlement process. In online processing, the transaction information is sent, normally via the verifier for negative database review, to the online processor. If the purchaser's bank is a member of the online service, the purchaser's account is checked for available funds and a hold placed against the account for the amount of the purchase followed by posting the debit against the account holders account during subsequent bank processing, thereby assuring that funds are available for payment of the purchase. The proceeds, i.e., the total transaction amount are then deposited in the merchant's account. If the purchaser's bank is not a member of Visa POS Check Service or SafeCHECK, the transaction is processed through the ACH network. With online processing the merchant is assured that the funds are available.

Electronic checking provides considerable advantages over the physical processing of paper checks in terms of speed and fraud protection. However, there is still a need for a method that will further expedite the settlement of electronic check transactions when some of the transactions are off-line transactions processed through an off-line settlement entity, normally the ACH network, and some of the transactions are online transactions, i.e., transactions processed through online processors. Specifically, a method is needed that will increase the rapidity of settlement, while minimizing the number of steps, and thereby the cost, of settling transactions. The present invention is directed to providing such a method.

### SUMMARY OF THE INVENTION

In accordance with the present invention, a method is provided for expedited settlement of a plurality of electronic transactions, including both off-line and online transactions. Generally, the method comprises collection by an entity, referred to herein as a settlement processor, of transaction information regarding a plurality of electronic check transactions made by a plurality of merchants, interrogating and identifying the information according to the nature of the transaction, and then processing each transaction for settlement according to whether it is an off-line transaction or an online transaction.

More specifically, the present method is comprised of the steps of 1) collecting electronic transaction information relating to a plurality of merchant transactions, 2) periodically downloading the transaction information to a settlement entity that interrogates and identifies the transaction information to determine for each merchant which of the merchant's transactions are transactions to be settled by off-line settlement, and which transactions have previously been processed by an online processor, 3) electronically transmitting off-line settlement transactions from the settlement processor to an off-line settlement entity, 4) creating due to/from entries to settle with online agencies such as SafeCHECK and Visa POS Check Services, and 5) crediting the merchant from the settlement processors account for transactions previously debited by an online processor.

In the present invention, the merchant swipes a check to obtain the raw MICR, which is transmitted to the verifier with the amount of the purchase and the merchant's identification. In the case of transactions to be settled through the ACH network, the information is transmitted for check verification, which means that the check information is only to be compared with the negative database. However, the transaction may also be sent for conversion or guarantee by the settlement processor. In addition to check conversion, the merchant may also arrange with the settlement processor for a guarantee that funds will be available for payment of the transaction amount.

If the transaction is for conversion by the settlement processor, the transaction information transmitted from the merchant, in addition to the raw MICR and the transaction amount, further includes a transaction code used to identify the transaction as being for conversion or guarantee. In the case of transactions that are guaranteed by the settlement processor, additional instructions agreed between the settlement processor and the merchant may also be sent with the transaction information designating criteria to be used by the verifier in evaluating whether or not to authorize payment of the check.

Upon receipt of the information, the verifier checks the information against the negative database, and applies any approval evaluation criteria sent with the transaction information. Such criteria may include, for example, instructions to disapprove the transaction if the purchaser is attempting to write more than a designated minimum number of checks within a given time period, or if the amount of the check exceeds a designated amount, or if the total checks from the purchaser exceed a predetermined amount within a given time period. The criteria may also include conditions under which manager approval is required at the point-of-sale.

The verifier, in addition to advising the merchant whether the transaction is approved or declined, also stores the transaction information, including disposition of the transaction, in a database accessible by the settlement processor. Periodically, e.g., hourly, the settlement processor downloads the transaction information in the database for settlement processing.

In addition to transactions requiring off-line settlement, many merchants also use the services of an online processor, such as Visa POS Check Service or SafeCHECK to process at least some of their transactions. In the case of online transactions, the transaction information is sent to the online processor, normally via the verifier, which checks the negative database. The online processor then checks the customer's bank account and places a hold against the account for the amount of the check if funds are available.

Each merchant utilizing the system periodically “batches out,” e.g., totals the value of transactions since the last batch-out. The batch-out time and amount is also provided to the settlement processor. When the transaction information is downloaded, the settlement processor interrogates the information to identify merchants who have batched out since the last download. The transaction information for these merchants is then further processed.

The downloaded information is interrogated to identify transactions for verification only, and which transactions were for conversion. Verification only transactions are not processed by the settlement processor, since no funds settlement is required for these transactions. Transactions requiring conversion by the settlement processor are further interrogated and identified as off-line settlement transactions, i.e., transaction to be settled to an off-line settlement entity, such as the ACH network, and online transactions, i.e., transactions previously sent to an online processor.

The settlement processor then sends off-line settlement transactions directly or indirectly through the ACH network or other off-line settlement entity for settlement. For brevity, the invention will be described in the context of processing off-line transactions through the ACH network. It will be understood, however, that reference to the ACH network also envisions the use of other off-line settlement networks. Preferably, off-line settlement transactions are sent indirectly to the ACH network by first transmitting the transactions from the settlement processor to the applicable merchant's bank, with the merchant's bank forwarding the transactions to ACH. By transmitting through the merchant's bank, the bank can immediately credit the merchant's account for the value of the settlement, thereby making a single deposit to the merchant's account and expediting availability of the funds to the merchant.

Information regarding online settlements is separately identified by the settlement processor, who credits the merchant's account from the settlement processor's direct deposit account (DDA) with a single deposit equal to the proceeds due to the merchant from the online transactions since the last batch-out. The settlement processor, in turn, creates due from the online processor entries to an account owned by the settlement processor to balance the DDA.

In addition to the transaction information, the point-of-sale terminal may also capture and store a digital image of the check. This image is also transmitted to an image archive system for storage and download by the settlement processor. After transactions are processed, the check image is stored in a database that is accessible via the Internet by the merchant. In cases where the system is provided to the merchant by the merchant's bank, the database is also accessible by the merchant's bank. Through the use of passwords, the bank may access the transaction information and check images for all of the bank's merchants. The merchants may access information relating to all of the merchant's transactions. If a merchant has several stores, the manager of each store may access information relating to transactions of their store.

Check image information is also valuable in collections. If a check is dishonored and collection is required, a copy of the check can be attached to the collection letter. Also, in instances where electronic processing of a check is refused, a copy of the check image can be alternatively processed as an indemnity copy of the check.

### BRIEF DESCRIPTION OF THE DRAWINGS

FIG. 1 is a flow chart of the present system showing the interrelationship of the parties to the transaction process.

FIG. 2 is flow chart of the steps taken by the settlement processor.

### DETAILED DESCRIPTION OF THE INVENTION

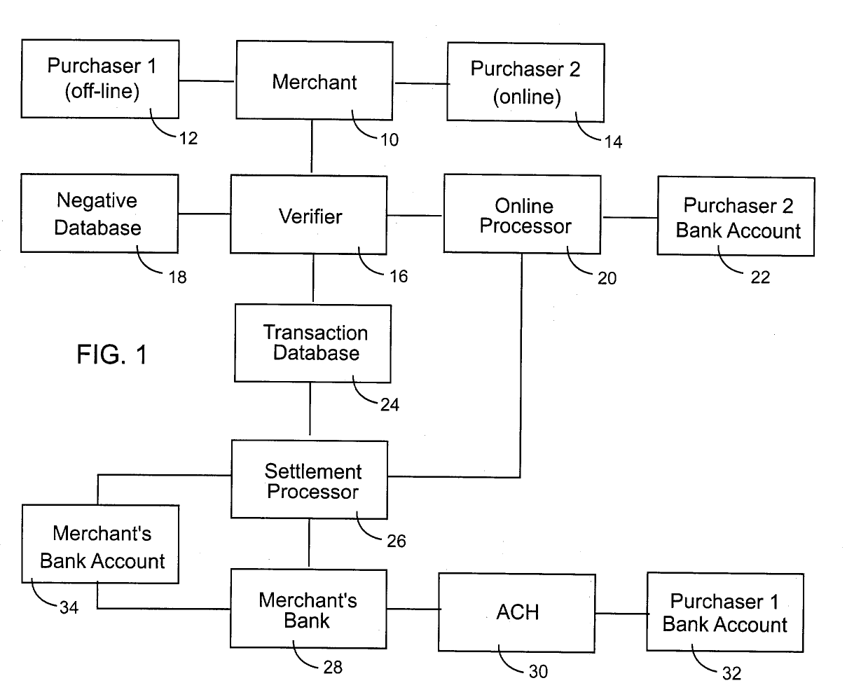

As illustrated in FIG. 1, merchant 10 may receive purchase information from purchasers whose transactions will be processed off-line, e.g., through the ACH network, as represented by Purchaser 1 at 12, or purchasers whose transactions will be processed online, e.g., by an online processor such as the Visa POS Check Service network or SafeCHECK, these latter purchasers being represented by Purchaser 2 and 14. In either case, the merchant scans a check, either blank or completed, received from the purchaser to acquire MICR information. The raw MICR is then transmitted along with the purchase amount, merchant information, and any transaction codes, to Verifier 16. Additional ID information such as drivers license may also be transmitted. Verifier 16 then checks the transaction against negative database 18 and sends an advisory message back to merchant 10 for display on the merchant's terminal. The message may advise that no negative information was found in the database, or that the transaction has been disapproved due to information in database 18 and/or because the proposed transaction is outside of the parameters forming a part of the transaction codes. If the transaction is disapproved, the advisory message may include a telephone number for the purchaser to call for further information.

If the purchase is being made by Purchaser 2 for online processing, Verifier 16 transmits the transaction information to Online Processor 20. Online transactions from different merchants may be directed to different online processors, depending on the online processing service used by the merchant. If the purchaser's bank is a subscriber to the online processor's service, Online Processor 20 will send the transaction to Purchaser 2's bank account 22 for verification of account status, availability of funds, holding the funds and subsequent processing of the debit. If the purchaser's bank is not a subscriber, the transaction will be returned to the Verifier for off-line ACH processing.

Verifier 16 stores information about all transactions in a transaction database 24 for periodic retrieval by Settlement Processor 26 for sorting and settlement processing. Settlement Processor 26 sends off-line settlement transactions to Merchant's Bank 28. Different merchant's banks may be used for different merchants depending on the merchants' banking relationships.

Merchant Bank 28, in turn, sends the off-line settlement information to the ACH network 30 for settlement and credits Merchant's Bank Account 34. ACH network 30 debits Purchaser 1 Bank Accounts 32 for each transaction. and in some cases credits Merchant's Bank Account 34. However, in order to expedite deposit of funds into Merchant's Bank Account 34, Merchant Bank 28 may immediately deposit the funds into Merchant's Bank Account 34 when the transaction information is received from Settlement Processor 26.

Settlement Processor 26 also acts as a settlement entity in online transactions by crediting Merchant's Bank Account 34 and debiting settlement account for Online Processor 20. For example, Settlement Processor 26, using a deposit account, may credit Merchant's Bank Account 34 for the proceeds of the online transaction, and debit an internal due from processor account either before or after Merchant's Bank Account 34 is credited.

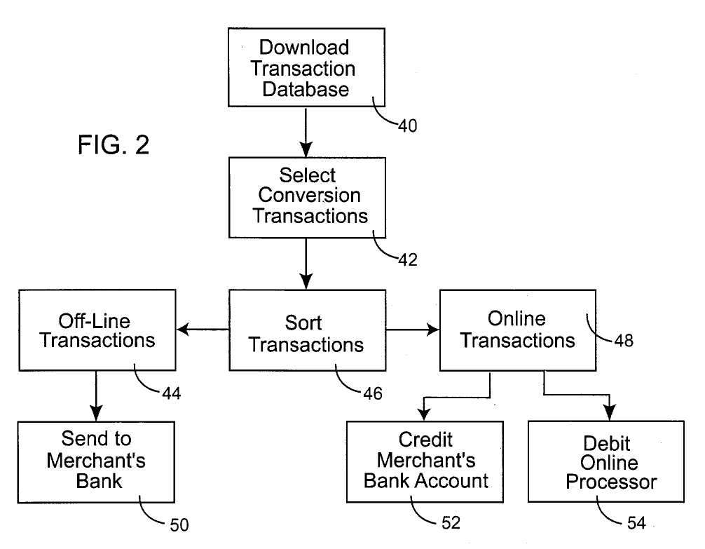

FIG. 2 illustrates the steps undertaken by Settlement Processor 26 during settlement of the transactions. Periodically, Settlement Processor 26 downloads transaction information from transaction database 24 (40). Transactions that Settlement Processor 26 has undertaken to convert are selected (42). The conversion transactions are then interrogated and identified as (46) Off-line transactions (44) and Online transactions (46). Off-line transactions are sent to the Merchant's bank (50) for processing through the ACH network. Settlement Processor makes a single deposit the Merchant's bank account (52) for online transactions, and debits an internal due from processor account t (54).

Thus, the present system provides several advantages in the settlement of electronic check transactions by using a single settlement entity to manage the settlement of both off-line and online transactions. As a result, paperwork and related costs are minimized, the burden of handling these transactions is removed from the banks, and funds are more expeditiously deposited into the merchant's account.

Certain modifications and improvements will occur to those skilled in the art upon a reading of the foregoing description. It should be understood that all such modifications and improvements have been deleted herein for the sake of conciseness and readability but are properly within the scope of the following claims.

What is claimed is:

1. A method of settling a plurality of electronic check transactions comprising:
a) acquiring transaction information relating to a plurality of electronic check transactions by a merchant;
b) interrogating and identifying the transaction information to determine which of said transactions require off-line settlement and which of said transactions were previously settled online by an online processing entity;
c) transmitting transactions requiring off-line settlement to an off-line settlement entity;
d) creating due from processor entries to an internal account; and
e) crediting said merchant for the value of the transactions previously settled online or offline.

2. The method of claim 1, wherein transactions requiring off-line settlement are transmitted to a bank where said merchant maintains an account.

3. The method of claim 2, wherein the merchant's bank credits the merchant's account for the proceeds of the off-line settlement transactions before settlement by the off-line settlement entity.

4. The method of claim 1, wherein said transaction information is sent to a verification entity for verification and storage in a database, and said information is periodically acquired from said database.

5. The method of claim 1, further including debiting said online processing entity for the amount credited to the merchant.

6. The method of claim 1, further including the comparison of the sum of the off-line and online transactions with a total provided by the merchant.

7. The method of claim 1, wherein the transaction information for each transaction is comprised of merchant identification, customer MICR number, the amount of the transaction, and an identifier designating the party to receive the transaction information.

8. A method of settling a plurality of purchases by purchasers from a merchant wherein payment is made by checks including some purchases requiring off-line settlement and other purchases requiring online settlement comprising:
a) acquiring transaction information relating to each purchase including the MICR information of the check presents by the purchaser, the amount of the purchase, and the merchant's identification;
b) interrogating the transaction information to identify transactions requiring off-line settlement and transactions previously settled by an online processing entity;
c) transmitting transactions requiring off-line settlement to an off-line settlement entity for settlement;
d) crediting the merchant for the value of transactions previously settled online or offline; and
e) debiting an internal due from processor account for transactions previously settled online.

9. The method of claim 8, wherein transactions requiring off-line settlement are transmitted to a bank where said merchant maintains an account.

10. The method of claim 9, wherein said bank forwards the off-line settlement transactions to an off-line settlement entity for off-line settlement and credits the merchant's account for the proceeds of the off-line settlement transactions before settlement by the offline settlement entity is completed.

11. The method of claim 8, wherein said transaction information is sent from the merchant to a verification entity for verification and storage in a database, and said information is periodically acquired from said database.

12. A method of electronically processing a plurality of transactions by purchasers from a merchant wherein payment is made by electronic check, some of said transactions requiring off-line settlement and other of said purchases requiring online settlement comprising:
a) for each transaction, scanning a check provided by the purchaser to acquire MICR information;
b) transmitting transaction information to a verification entity, said transaction information including said MICR information, the purchase amount, merchant, identification information, the identification of a settlement entity, whether the transaction is to be processed by off-line settlement or online settlement, and whether the transaction is for verification or conversion;
c) comparing said transaction information against a database of information relating to previous check transactions to verify or disapprove the transaction;
d) forwarding transactions designated for online settlement to an online processing entity;
e) storing information relating to said transactions in a database;
t) periodically downloading said database to a settlement processor;
g) selecting transactions designated for conversion;
h) forwarding transactions designated for off-line settlement from said settlement processor to an off-line settlement entity; and
i) crediting said merchant with funds from said settlement processor for the value of said online or offline settlement transactions.

13. The method of claim 12, wherein said transactions designated for off-line settlement are forwarded to a bank where the merchant maintains an account, and then forwarded from said bank to the off-line settlement entity.

14. The method of claim 12, further including the step of debiting an internal due from processor account by the settlement processor for the value of the online transactions.

15. The method of claim 12, further including the step of acquiring an image of said check, said check image also being transmitted to an image archive database.

16. The method of claim 12, further including the step of returning said
check to the purchaser.

17. The method of claim 12, including the step of debiting bank accounts of purchasers by the online processing entity for the online settlement transactions.

18. The method of claim 12, including the step of debiting the bank accounts of purchasers by the off-line settlement entity for the value of off-line settlement transactions.

19. The method of claim 12, wherein the off-line settlement entity is an Automated Clearing House network.

20. The method of claim 12, wherein said transaction information further includes criteria for evaluating whether a transaction should be verified or disapproved.
